(19) United States
(12) Patent Application Publication
(10) Pub. No.: US 2026/0246254 A1
(43) Pub. Date: Aug. 20, 2026

(54) MULTI-STACK JOINT PACK FOR BUSWAY SYSTEMS

(71) Applicant: VERTIV CORPORATION, Westerville, OH (US)

(72) Inventors: Adrian Sheridan, Ras Al Khaimah (AE); Marc A. Dawson, Derry (IE); Stephen Kerr, Londonderry (IE); Sreehari Thekkekara Katupurathillam, Ras Al Khaimah (AE); Karol McDermott, Moville (IE)

(21) Appl. No.: 19/465,208

(22) Filed: Jan. 30, 2026

Related U.S. Application Data
(60) Provisional application No. 63/760,461, filed on Feb. 19, 2025.

(51) Int. Cl. H02G 5/08; H02G 5/06

(52) U.S. Cl. CPC H02G 5/08; H02G 5/061; H02G 5/068

(57) ABSTRACT

A stack joint pack for electrically coupling stacks of busways includes a pack housing having opposing ends configured to receive ends of stacked busway segments, a plurality of insulative dividers, a plurality of conductive channels formed between adjacent ones of the plurality of insulative dividers and configured to receive a plurality of respective sets of buses of the stacked busway segments, and a plurality of bridge buses disposed in the plurality of conductive channels configured to electrically interconnect the buses of the stacked busway segments.

### CROSS REFERENCE TO RELATED APPLICATION

This nonprovisional application claims the benefit of priority of U.S. Application Number 63/760,461 filed Feb. 19, 2025, which is hereby incorporated by reference in its entirety.

### BACKGROUND

Data centers are required to support rapidly increasing computational demand driven by high-performance computing, artificial intelligence, and data-intensive applications. As a result, data center operators must continuously adapt their infrastructure to accommodate higher power densities, changing equipment layouts, and evolving operational requirements. Electrical power distribution systems play a critical role in enabling this adaptability.

Existing open channel busway products may provide a single open track busway with a maximum International Electrotechnical Commission (IEC) rating of 1000 Amps (A). Even upon increasing the housing size to accommodate larger conductors, the IEC rating may be improved to 1400A. However, as Graphics Processing Unit (GPU) power demands continue to rise (e.g., Nvidia Blackwell B200™ GPU), the existing 1000A amperage open channel busway may fall short, necessitating users currently to resort to enclosed fixed-position tap off slot busways, which compromises flexibility and scalability.

There is therefore a growing need for interconnectable busway systems that provide enhanced flexibility and scalability within data center environments. Such systems should enable seamless electrical and mechanical interconnection between busway segments, allow for straightforward extension or reconfiguration as power demands change, and support varying power capacities without requiring substantial redesign of the overall distribution network.

### SUMMARY

According to one aspect, disclosed herein is a stack joint pack for electrically coupling stacks of busways. In embodiments, the stack joint pack includes a pack housing having opposing ends configured to receive at least ends of stacked busway segments, a plurality of insulative dividers disposed in the pack housing, a plurality of conductive channels formed between adjacent ones of the plurality of insulative dividers configured to receive a plurality of respective sets of buses of the stacked busway segments, and a plurality of bridge buses disposed in the plurality of conductive channels, each bridge bus configured to electrically interconnect a respective set of the buses of the stacked busway segments configured to be received in the opposing ends of the pack housing.

In some embodiments, the pack housing includes a first housing, a second housing, and opposing sidewalls disposed between and removably attachable to the first and second housings.

In some embodiments, the opposing sidewalls are configured to secure to at least one mechanical joint block of the stacks of busways.

In some embodiments, the plurality of insulative dividers are parallel and are mounted to or integrally formed with one of the first housing and the second housing.

In some embodiments, the plurality of insulative dividers extend from the first housing toward the second housing and are parallel to the opposing sidewalls.

In some embodiments, the plurality of bridge buses are mounted in the pack housing by at least one transverse mounting post.

According to another aspect, disclosed herein is a stack joint pack for electrically coupling busway segments. In embodiments, the stack joint pack includes, a pack housing having opposing ends configured to receive ends of aligned busway segments, a plurality of conductive channels formed in the pack housing and configured to receive buses of the aligned busway segments, and a plurality of bridge buses disposed in the conductive channels and configured to electrically interface with the buses of the aligned busway segments to facilitate electrical connections.

According to a further aspect, disclosed herein is a busway system. In embodiments, the busway system includes a plurality of stacks of busway segments including at least a first stack of busway segments and a second stack of busway segments, and a stack joint pack for electrically coupling the first stack of busway segments and the second stack of busway segments. In embodiments, the stack joint pack includes a pack housing having first and second opposing ends, wherein the first end is configured to receive ends of the first stack of busway segments and the second end is configured to receive ends of the second stack of busway segments, a plurality of insulative dividers disposed in the pack housing, a plurality of conductive channels formed between adjacent ones of the plurality of insulative dividers, each conductive channel configured to receive a plurality of respective sets of buses of the first and second stacks of busway segments, and a plurality of bridge buses disposed in each of the plurality of conductive channels, each bridge bus configured to electrically interconnect a pair of the buses of the first and second stacks of busway segments.

This summary is provided solely as an introduction to subject matter that is fully described in the following detailed description and drawing figures. This summary should not be considered to describe essential features nor be used to determine the scope of the claims. Moreover, it is to be understood that both the foregoing summary and the following detailed description are explanatory only and are not necessarily restrictive of the subject matter claimed.

### BRIEF DESCRIPTION OF THE DRAWINGS

Implementations of the present disclosure disclosed herein may be better understood when consideration is given to the following detailed description thereof. Such description refers to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 is a top, isometric view of a multiple (e.g., two in the illustrated embodiment) stack of busways, electrically interconnected with one another via a stack joint pack, with each busway being an open track busway, in accordance with an example embodiment of the present disclosure;

FIG. 2 is a cross-sectional view of a multiple stack (e.g., two in the illustrated embodiment) of aluminum conductor busway segments coupled by at least one mechanical joint block, in accordance with an example embodiment of the present disclosure;

FIG. 3 is a cross-sectional view of a multiple stack (e.g., two in the illustrated embodiment) of copper conductor busway segments coupled by at least one mechanical joint block, in accordance with an example embodiment of the present disclosure;

FIG. 4 is an isometric view of a mechanical joint block, in accordance with an example embodiment of the present disclosure;

FIG. 5 is a fragmentary perspective view of a stack joint pack (e.g., double stack joint pack in the illustrated embodiment) for electrically interconnecting busway segments, in accordance with an example embodiment of the present disclosure;

FIG. 6 is an isometric view of the stack joint pack, per the embodiment shown in FIG. 5;

FIG. 7 is an end perspective view of the stack joint pack, per the embodiment shown in FIG. 5;

FIG. 8 is an exploded view of the stack joint pack, per the embodiment shown in FIG. 5;

FIG. 9 is an isometric view of a tap off unit, in accordance with an example embodiment of the present disclosure;

FIG. 10 is a perspective view of an electrical distribution system including a plurality of tap off units mechanically and electrically coupled to a multiple stack of busways, in accordance with an example embodiment of the present disclosure;

FIG. 11 is an end view of a multiple stack (e.g., three in the illustrated embodiment) of aluminum conductor busway segments interconnected by at least one mechanical joint block, in accordance with an example embodiment of the present disclosure; and

FIG. 12 is an end view of a multiple stack (e.g., four in the illustrated embodiment) of aluminum conductor busway segments interconnected by at least one mechanical joint block, in accordance with an example embodiment of the present disclosure.

### DETAILED DESCRIPTION

Aspects of the disclosure are described more fully hereinafter with reference to the accompanying drawings, which form a part hereof, and which show, by way of illustration, example features. The features may, however, be embodied in many different forms and should not be construed as limited to the combinations set forth herein; rather, these combinations are provided so that this disclosure will be thorough and complete, and will fully convey the scope. The following detailed description is, therefore, not to be taken in a limiting sense.

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present), and B is false (or not present), A is false (or not present) and B is true (or present), and both A and B are true (or present).

In addition, the use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “embodiments” means that a particular element, feature, structure, or characteristic described in connection with the embodiment is included in at least one embodiment disclosed herein. The appearances of the phrase “in embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Disclosed herein are multi-stack, open track busway solutions that provide the necessary power capacity for evolving GPU requirements while maintaining adaptability and scalability in industrial settings. The solutions disclosed herein aim to cater to the increasing power demands of modern computing systems without sacrificing ease of installation and future expansion possibilities. In an embodiment, a double stack of busways may be provided with at least one being an open track busway, but it is to be understood that two or more busways may be provided in a stack (e.g., two, three, four, etc.), with at least one being an open track busway. Each busway may provide multiple buses (e.g., 3-8) together configured to facilitate power transmission and/or data communication therethrough.

The increased power capacity within the multi-stack may be provided by electrically interconnecting the busways of the stack using one or more multi-stack joint packs or “stack joint pack” as used herein. Each stack joint pack is configured to mechanically and electrically interconnect the busways, and more specifically busways segments arranged end-to-end, and in embodiments may provide fixing points for joint side covers and additional hanging bracket mounting position options along the main busway length. In embodiments, each stack joint pack facilitates a direct electrical interconnect between the busways and busway segments of the given stack joint pack, while the housing of the given stack joint pack may yield the necessary electrical shielding between the sets of busbars within the associated busways, as well as around the interconnected busbars, overall.

One or more mechanical joint blocks may be positioned between an adjacent pair of stacked busways. Each mechanical joint block serves multiple functions. For example, each mechanical joint block connects, via a set of connecting plates associated therewith, two respective channels of the corresponding adjacent busways, thereby vertically supporting the adjacent busways relative to one another (e.g., hang relative to one another via the connecting plates). Each end of a given mechanical joint block may carry at least a pair of grab screws, each respective grab screw oriented toward one of the opposing busways, with the at least four grab screws of the mechanical joint block working together to hold the opposing open track busways longitudinally (e.g., along the relative length of each busway) in place relative to the other. Each mechanical joint block may further define a pair of mounting positions (e.g., threaded through holes) in opposite distal faces thereof.

In use, the multiple stack, scalable, open track solution disclosed herein enables open track connection of one or more high density tap offs anywhere along the longitudinal length of the stack where an open track section is present. In an embodiment, tap off placement may be limited by the placement of the one or more stack joint packs that block access to the open track and the availability of open track on a given busway (e.g., a chosen busway may only be a bus carrier and not have an open track). The provision of multiple busways facilitates a multiplier effect on the available current (e.g., amperage) compared to a single busway set up. For example, the multiplier effect may be a 2X UL (Underwriter’s Laboratory) rating multiplier or a 1.8 IEC rating multiplier when considering a double stack configuration (e.g., 1800A – 2250A available IEC; 1600A – 2000A available UL). For example, the multiple stacking of the busways and the related electrical interlinking thereof may permit an increase in the ampere rating of each busway in the stack, thereby facilitating keeping up with rack densification yet still allowing flexibility in tap off unit placement.

In accordance with an embodiment of the present disclosure, a busway system includes multiple busways, one or more stack joint packs, and one or more mechanical joint blocks. The multiple busways are arranged to form a stack of busways, with each busway including a respective plurality of busway segments. Each busway includes multiple buses and a segment housing, the segment housing configured to carry and electrically insulate the buses from one another. One or more busways may define an open track therein to facilitate electrical coupling with one or more tap off units. The one or more stack joint packs electrically couple with the busways, with each stack joint pack selectably electrically interconnecting a plurality of respective sets of busway segments. The one or more mechanical joint blocks may be mounted between an adjacent pair of the busways, for example, with a first busway located above and carrying a second busway via a corresponding mechanical joint block.

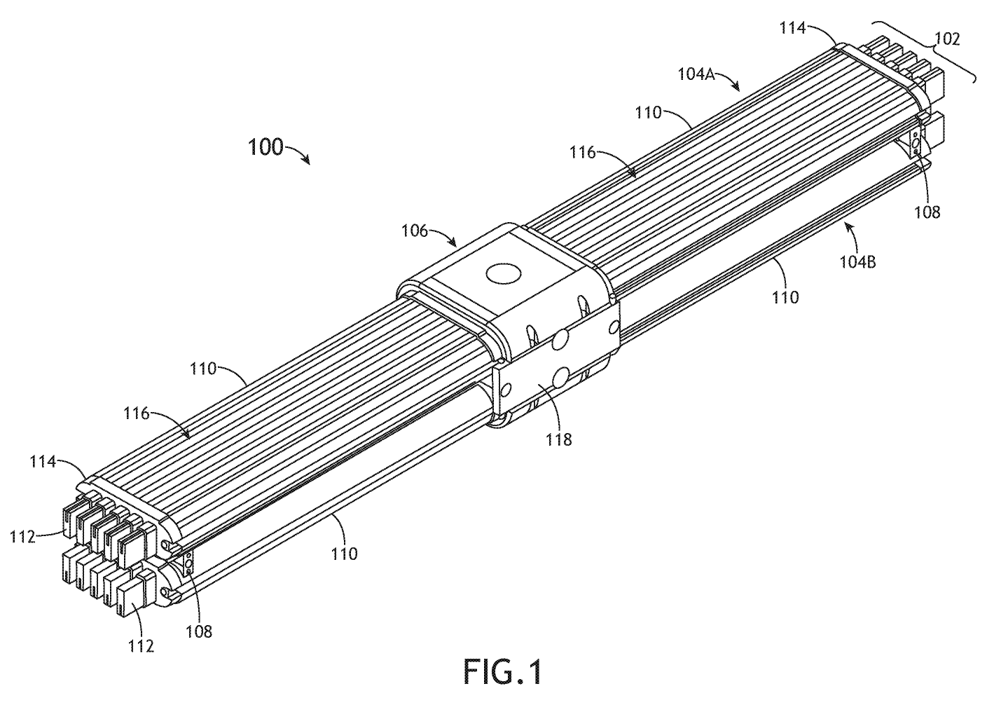

FIG. 1 illustrates a multi-stack, open track busway system 100 in accordance with an example embodiment of the present disclosure. The busway system 100 generally includes a multiple (e.g., two shown in the illustrated embodiment) stack 102 of busways 104A, 104B, one or more stack joint packs 106 (e.g., of which one is illustrated), and multiple mechanical joint blocks 108. The illustrated busway system 100 includes a first (e.g., top/upper) busway 104A, and a second (e.g., bottom/lower) busway 104B as part of its multiple stack 102. Each busway 104A, 104B includes multiple busway segments 110 where each busway segment 110 may include one or more buses 112 and a concordant segment housing 114 configured to carry the buses 112 and electrically insulate the buses 112 from one another and a surrounding environment. Each busway segment 110 may be mechanically and electrically coupled (e.g., particularly electrically coupling select buses 112) to one another via the one or more stack joint packs 106, as well as being ultimately coupled to a source of power (not shown).

Per the illustrated embodiment, both busways 104A, 104B may define an open track 116 (e.g., through a corresponding segment housing 114 and facilitating electrical coupling with one or more buses 112) configured to facilitate electrical coupling of a set of buses 112 of a corresponding busway 104A, 104B to one or more high-density tap off units (not shown). While the busway system 100 shows a double stack busway system, it is to be understood that the busway system 100 may be expanded to include three or more busways 104 with the stack joint pack 106 being expanded accordingly to electrically interconnect and house the concordant buses 112.

The one or more stack joint packs 106 are configured to electrically couple with the busways 104A, 104B (specifically, the buses 112 thereof), respectively spaced at periodic intervals when more than one such stack joint pack 106 is employed, as well helping to mechanically house them, as well. In an embodiment, each stack joint pack 106 is configured to interconnect a first pair of busway segments 110 of the first busway 104A and a second pair of busway segments 110 of the second busway 104B. In an embodiment where three or more busways are involved, there may, of course, be multiple respective sets of busway segments 110 of the respective busways selectably interconnected (e.g., within vertical bus rows) within each stack joint pack 106. The ability to electrically couple the respective buses 112 (e.g., of the busway segments 110) of the busways 104A, 104B at periodic intervals via the one or more stack joint packs 106 may yield a higher available amperage (e.g., double or nearly double) within a given busway than what would be available via a single such open-track busway.

In embodiments, the individual segments 110 may have a longitudinal length from, for example, about 10 feet to about 15 feet such that the stack joint packs 106 are spaced at intervals of about 10 feet to about 15 feet along the stack, with each stack joint pack 106 respectively interconnecting two respective sets of busway segments 110 (e.g., within a vertical column of a double stack configuration). In an embodiment, the spacing of the stack joint packs 106 may be determined based on the electrical requirements of the busway system 100 (e.g., spaced to avoid any electrical overloading while minimizing the cost of including further stack joint packs 106 beyond what is needed to meet the electrical requirements of the busway system 100). In embodiments, each stack joint pack 106 may further define a pack housing 118 configured to electrically insulate the electrical connections therein from one another and from a surrounding environment, as well as receiving a set of corresponding ends of the busway segments 110 therein. In embodiments, the pack housing 118 may be made of plastic, composite, or other insulating material that is also sufficiently mechanically durable.

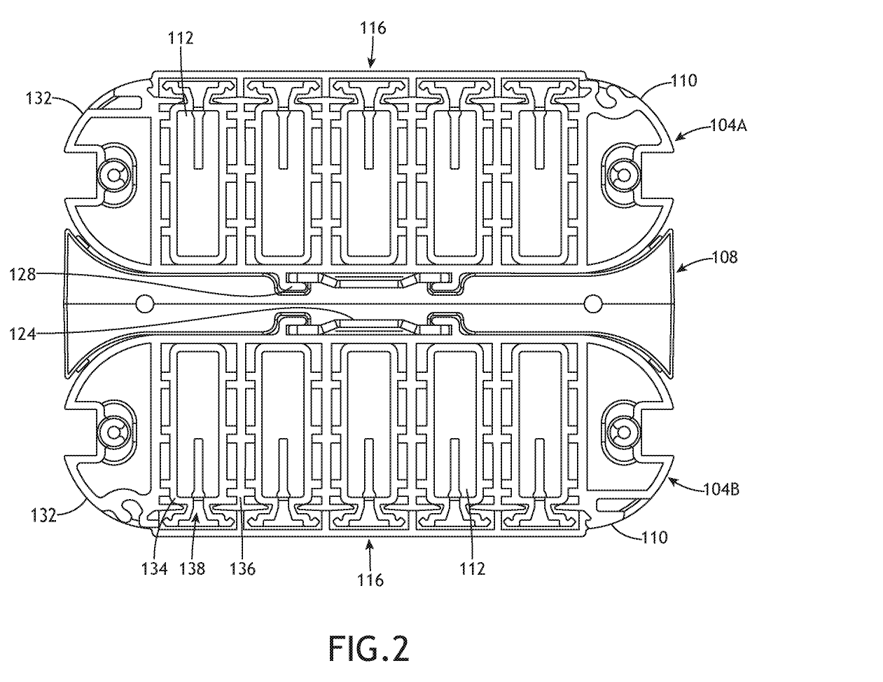

FIG. 2 is a cross-sectional view illustrating the stacked busways, and more specifically, the disposition of the first busway 104A and the second busway 104B (or segments 110 thereof) at a position where they are joined by a mechanical joint block 108. Each busway 104A, 104B may include a busway casing 132, multiple insulating bodies 134, and multiple internal ribs 136, such as what is illustrated in US 2015/0311654 A1 (also now assigned to Vertiv Corporation), the contents of which are hereby incorporated by reference. The multiple insulating bodies 134 may be located within the busway casing 132 and may be configured to carry the respective buses 112 (e.g., busbars) therein. In embodiments, each of the respective buses 112 may be in the form of a slotted metal (e.g., aluminum or other conductive metal or alloy) bar configured to interconnect electrically with a conductor (not shown) of a tap off unit via a portion of the open track 116 (e.g., with the slotted portion thereof facing the open track 116). In an embodiment, the buses 112 may be an elongate metal portion. In an embodiment, the buses 112 may be formed via extrusion or forging, especially when using aluminum or aluminum alloys.

In some embodiments, some buses 112 may be slotted or not, depending on whether such buses 112 are to be positioned relative to an open track 116. For example, in some busway systems an open track 116 may be provided on the second busway 104B corresponding to the lower/bottom busway, while the first busway 104A corresponding to the upper/top busway may be of a simpler construction without longitudinal slotting which may permit the housing thereof to be stiffer. Further, in some embodiments, only the set of buses 112 of the second busway 104B may need be slotted to accommodate electrical coupling with one or more tap off units. That is, the set of buses 112 of the first busway 104B may be of a simpler, elongate strip design (e.g., reducing the cost thereof). Further, by limiting tap off unit electrical connection to the second busway 104B, the opportunity to electrically overload the system may be decreased, which is important since a system goal is to facilitate a higher available amperage.

In embodiments, each busway casing 132 defines an open longitudinal channel formed by a pair of spaced mounting tabs 128 positioned on a side opposite of the casing 132 opposite the open track 116 side. Each mechanical joint block 108 includes a mounting plate 124 configured to be received in the respective channel and interface with the overhanging mounting tabs 128 to retain the respective busway 104A, 104B to the mechanical joint block 108. In embodiments, the facing sides of the mechanical joint block 108 and the busing casings 132 have a matching profile.

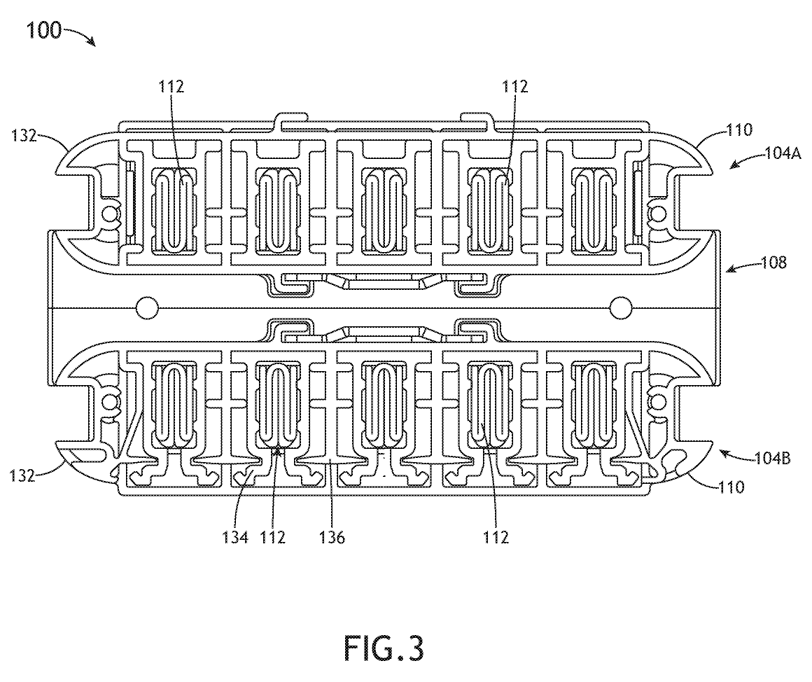

FIG. 3 is a cross-sectional view illustrating stack busways, and more specifically, the disposition of the first busway 104A and the second busway 104B (or segments 110 thereof) including the plurality of buses 112 implemented as a rolled metal construct. For example, each of the buses 112 may be a rolled copper, copper alloy, or tinned copper construct. In an embodiment, the rolled metal construct may approximate a “W” or “M” shape. In an embodiment, each of the buses 112, due to being roll-formed from sheet metal, may present an increased surface area for conduction (e.g., potentially improved electrical connectivity with one or more conductors of a given tap off unit). That is, the “W” or “M” shape may inherently yield a central, approximately U-shaped groove configured to receive one or more conductors (e.g., from one or more tap off units) therein, with any respective bus 112 being compression-sealed proximate the distal ends thereof (not expressly illustrated). Since the roll-forming process may yield a rolled metal construct having a central U-shaped groove therein, no further machining and/or processing thereof may be needed to yield an electrical interconnect groove therein. In embodiments, the multiple internal ribs 136 may extend from and into the busway casing 132 and may be configured to retain the insulating bodies 134 within the busway casing 132 and otherwise space the insulating bodies 134 from one another. In an embodiment, the busway casing 132 may be formed by an extrusion or other forming process and may be formed of a metal (e.g., aluminum or steel), plastic, or composite.

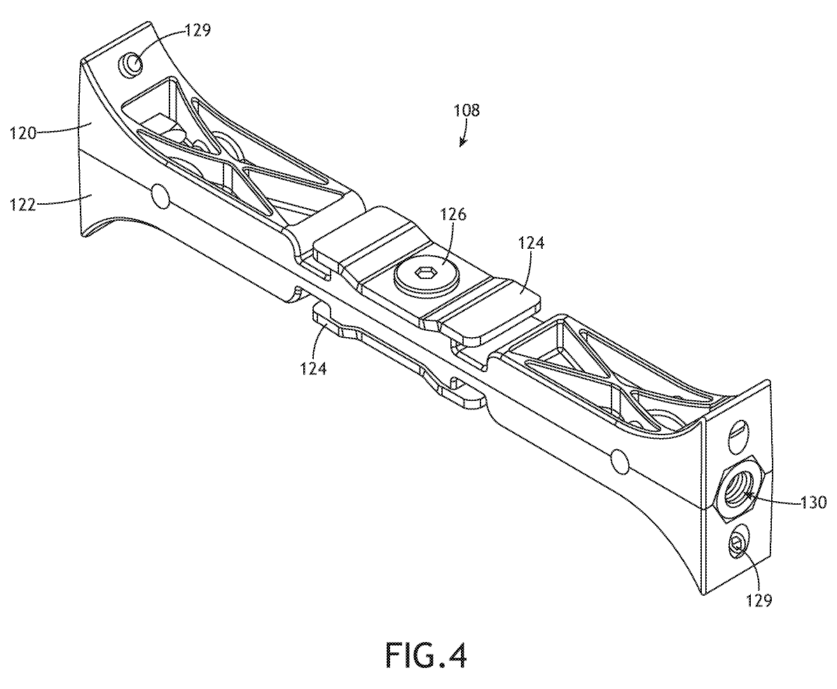

FIG. 4 illustrates the mechanical joint block 108 according to an embodiment of the present disclosure. In use, one or more mechanical joint blocks 108 may be mounted in spaced apart relation and between an adjacent pair of busways, for instance busways 104A, 104B shown in FIGS. 1-3. In embodiments, mechanical joint blocks 108 may be positioned proximal to a stack joint pack 106 and at one or more positions away from a given stack joint pack 106, for instance longitudinally spaced along a length of busway segments 110. In embodiments, each mechanical joint block 108 may include a first joint block section 120, a second joint block section 122, a pair of mounting plates 124, a section connector 126, multiple grab screws 129, and a set of distal face mounting ports 130. In embodiments, the first joint block section 120 and the second joint block section may be integrally formed, whereas the mounting plates 124 may be separately attached via one or more section connectors 126. In embodiments, the section connectors 126 may extend through each of the first joint block section 120, the second joint block section 122, and the set of mounting plates 124, thereby holding the formed assembly together. In an embodiment, the section connector 126 may be a threaded connector or other elongate connector capable of interconnecting the desired parts together.

Each mounting plate 124 may be respectively held by and between a corresponding pair of the mounting tabs 128 extending from a respective busway 104A, 104B or, more specifically, a concordant segment housing 114 (e.g., where a pair of mounting tabs 128 essentially define a mounting slot therebetween). In an embodiment where the busways 104A, 104B are aligned generally parallel to a floor, the mounting tabs 128 and the interconnecting section connector 126 may permit the weight of the lower busway 104B to be carried by the upper busway 104A. It is to be understood that a given lower busway 104B may be carried by an upper busway 104A (e.g., or a first set of busway portions 110 carrying a second set thereof, depending on the vantage point), in sum, by multiple such interconnecting combinations, given that multiple mechanical joint blocks 108 may, indeed, be employed between a pair of busways 104A, 104B.

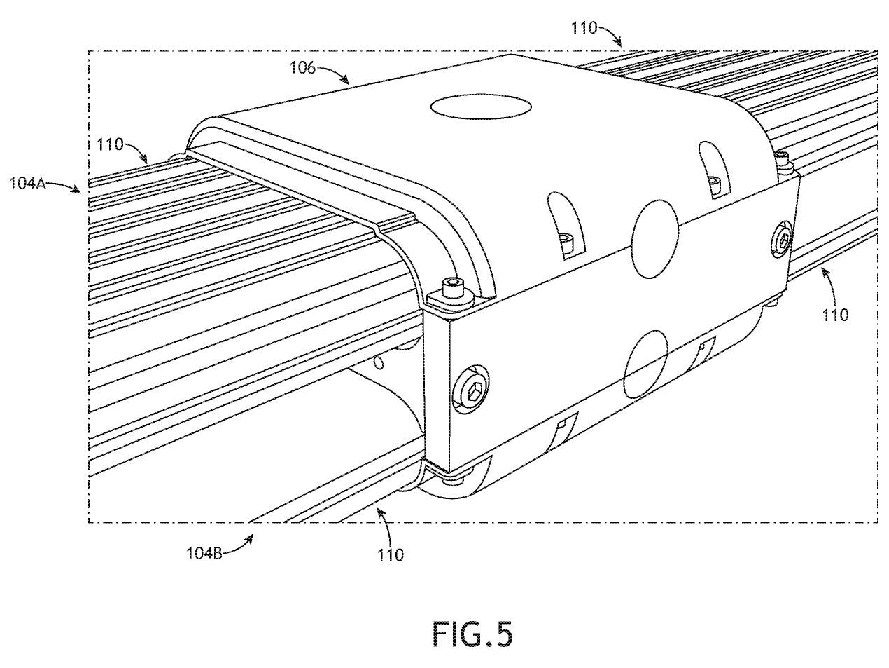

FIGS. 5-8 illustrate a stack joint pack 106 configured to be positioned at the juncture between longitudinally aligned segments 110 of a busway stack, for instance the segments 110 of the first and second busways 104A, 104B in the case of a double stack configuration. In use, each stack joint pack 106 electrically couples the segments 110 to provide a scalable and electrically continuous stack of busways, thus ultimately yielding a higher available amperage within each busway than what may otherwise be available without the presence of such stack joint pack 106. In the case of the double stack of busways 104A, 104B shown in FIG. 1, the stack joint packs 106 used therewith have a corresponding double stack joint pack configuration. In the case of a triple stack of busways, the stack joint packs for use therewith would have a triple stack joint pack configuration, and so forth. In use, the stack joint packs 106 may be used to extend the longitudinal length of the busways 104A, 104B while maintaining electrical continuity. In addition, the stack joint packs 106 enclose the buses 112 extending from the ends of the segments 110, thereby protecting and insulating the buses 112 from a surrounding environment.

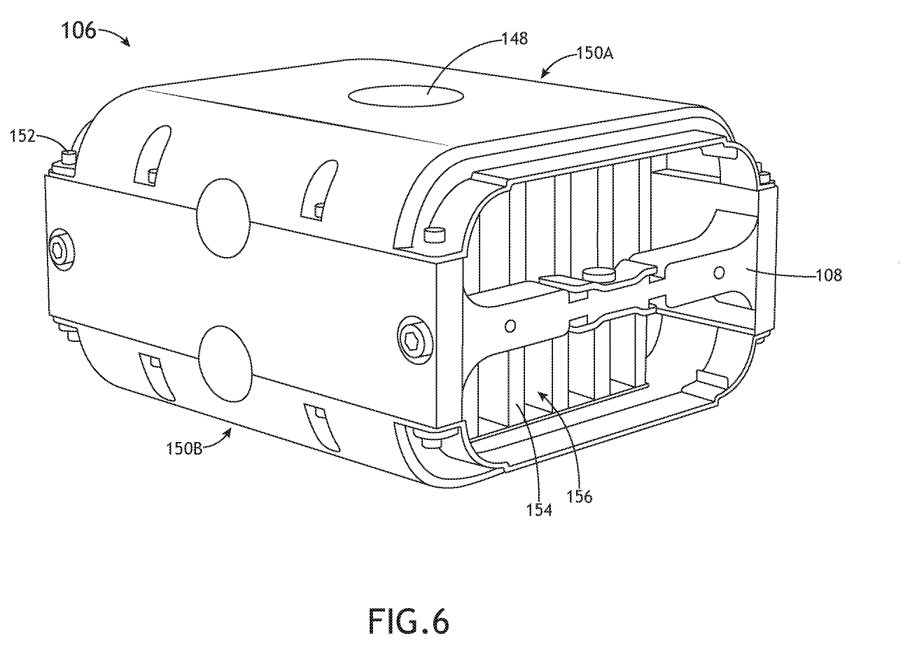

Referring to FIG. 6, each stack joint pack 106 generally includes a pack housing 148 having opposing ends configured to receive and secure therein facing ends of segments 110 of the stack. In embodiments, the pack housing 148 may include a first housing 150A and a second housing 150B configured to be removably secured together using a plurality of fasteners 152, for instance threaded fasteners. In a vertical stack configuration as shown in FIG. 5, the first housing 150A may correspond to the upper/top housing for interfacing with the longitudinally aligned segments 110 of the first busway 104A, whereas the second housing 150B may correspond to the lower/bottom housing for interfacing with the longitudinally aligned segments 110 of the second busway 104B. In embodiments, each stack joint pack 106 may further include or interface with a pair of mechanical joint blocks 108 for securing the ends of the segments 110 in the stack joint pack 106. For example, the mechanical joint blocks 108 may be part of the stack joint pack 106 assembly or may be part of the stacked busway assembly and secured to the stack joint pack 106.

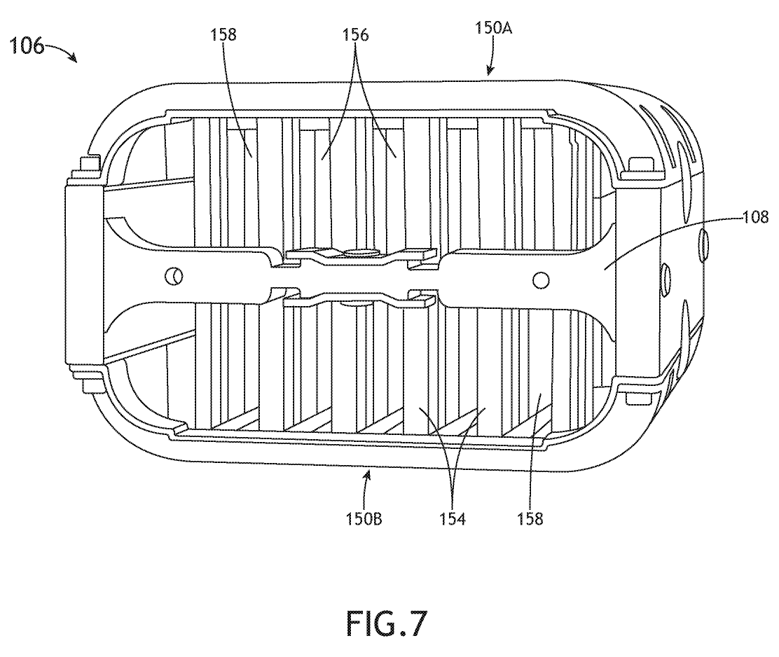

Referring to FIG. 7, each stack joint pack 106 includes a plurality of parallel insulative dividers 154 defining a plurality of parallel and distinct conductor channels 156 between adjacent ones of the parallel insulative dividers 154. When implemented as a vertical multiple stack 102 as shown in FIG. 5, the parallel insulative dividers 154 are oriented vertically to form vertical conductor channels 156. In embodiments, the number of conductor channels 156 may correspond to the number of buses 112 of the segments 110. For example, a separate conductor channel 156 may be provided for each bus 112. In another embodiment, a single conductor channel 156 may accommodate more than one bus 112 (e.g., an elongate ‘vertical’ conductor channel 156 may accommodate more than one ‘vertically’ aligned bus 112 such as two or more ‘vertically’ aligned buses 112).

In embodiments, each conductor channel 156 houses at least one bridge bus 158 configured to electrically interface with the ends of the sets of buses 112 extending from the facing ends of the segments 110 to facilitate electrical interconnections. In embodiments, the bridge buses 158 may be made of the same material and have the same profile as the buses 112 that they electrically couple with. For example, in the case of extruded aluminum buses 112, the bridge buses 158 may also be extruded aluminum having a matching profile, and in the case of folded copper buses 112, the bridge buses 158 may be folded copper having a matching profile. In use, each bridge bus 158 electrically interfaces with the facing ends of the respective buses 112 of longitudinally aligned segments 110 to allow current to flow from the bus 112 in one segment 110 to the bus 112 in the adjacent segment 110 through the stack joint pack 106.

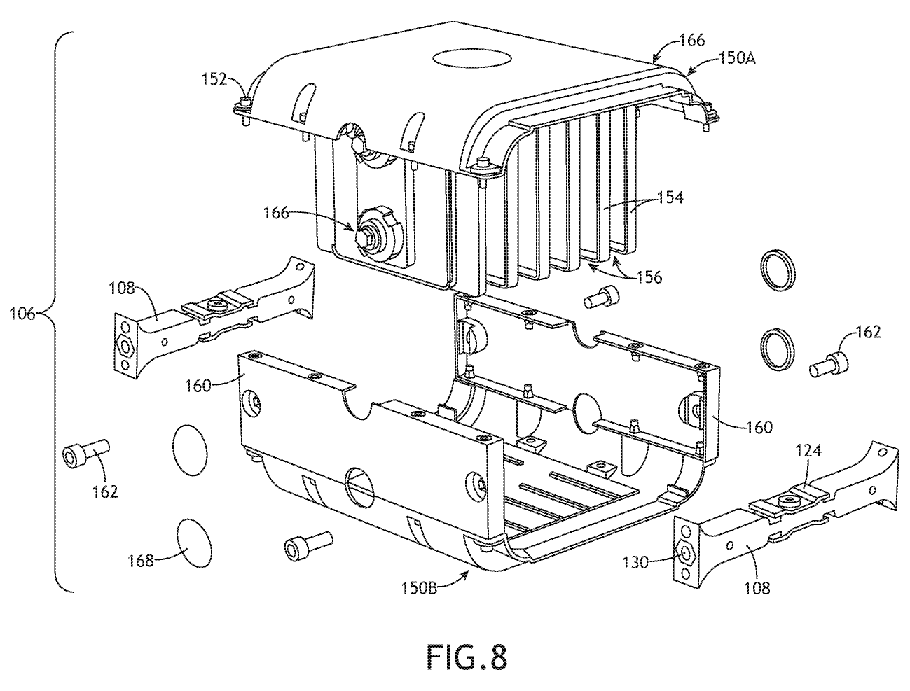

Referring to FIG. 8, in some embodiments the pack housing 148 may include a multi-piece construction generally including the first housing 150A, the second housing 150B, and opposing sidewalls 160 interconnecting the first and second housings 150A, 150B. In embodiments, the use of separate sidewalls 160 allows the pack housing 148 to be scaled in height/thickness to accommodate a double stack, triple stack, quad stack, etc. In embodiments, each mechanical joint block 108 (whether part of the pack housing 148 or part of the busway stack and received by the pack housing 148) may be positioned between the opposing sidewalls 160 and secured in place using threaded fasteners 162 received through the sidewalls 160 and engaged in the respective mounting ports 130 of the mechanical joint blocks 108. As described above, the mounting plates 124 of the mechanical joint blocks 108 engage the mounting tabs 128 implemented as channels or slots or overhangs formed on the segments 110 to retain the segments 110. In some embodiments, the pack housing 148 may be tightened to provide a clamping action on the ends of the segments 110. In embodiments, indicia in the form of a label, sticker, stamping, embossing, etc., may be provided on one or more of the first housing 150A and the second housing 150B to indicate the positions of the different buses 112.

In embodiments, the insulative dividers 154 may be carried by or integrally formed with one of the first and second housings 150A, 150B, for instance the first housing 150A as shown. In embodiments, the bridge buses (not shown) are mounted in their respective conductor channel 156 by at least one transverse element 166, for instance a dielectric element implemented as a mounting post. In embodiments, caps 168 may be used to cover access openings formed through portions of the first and second housings 150A, 150B and sidewalls 160 for accessing the transverse elements 166.

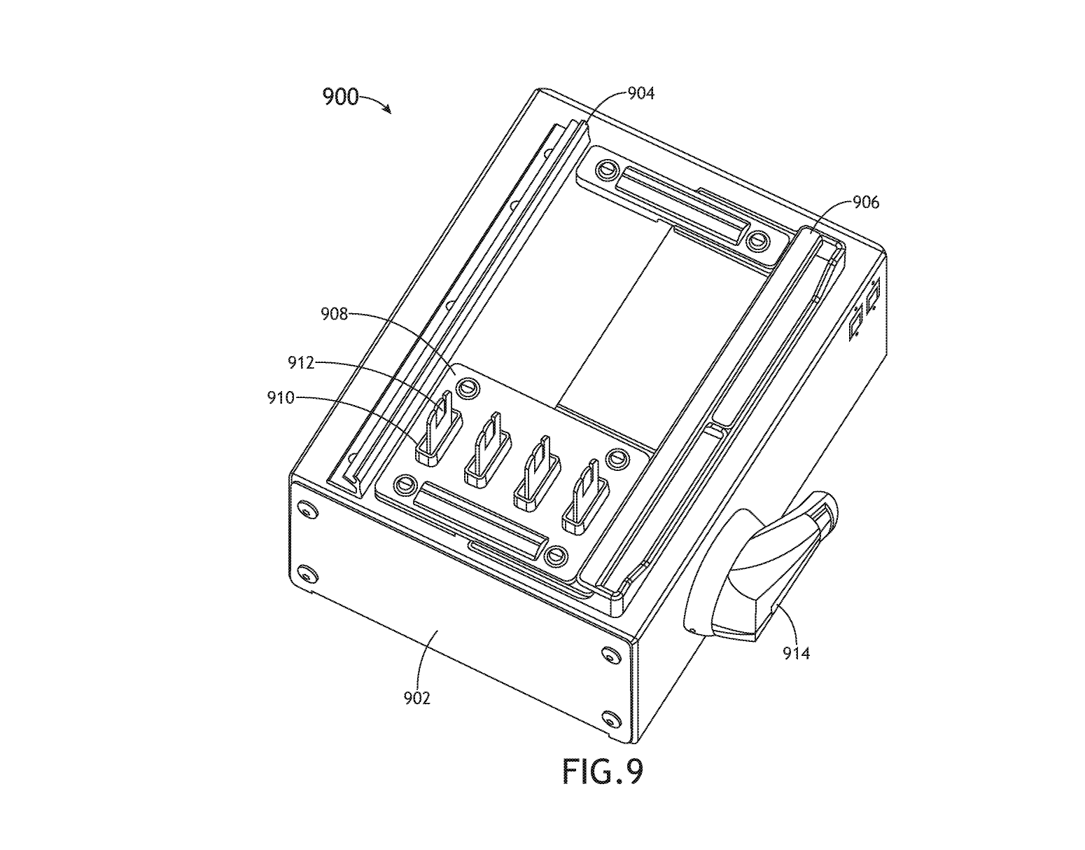

FIG. 9 illustrates a non-limiting example of a tap off unit 900 adapted to be mounted on the busway segments 110 at any desired open track location along the length thereof (considering the positions of the one or more stack joint packs 106) to define a spur connection with the busway segments 110. In embodiments, the tap off unit 900 may include a housing 902, retaining flanges 904, 906 provided on the housing 902 and configured to secure to the open track 116, a top plate 908 forming guide slots 910 guiding male contacts 912, and a lifting lever 914 for extending and retracting the male contacts 912.

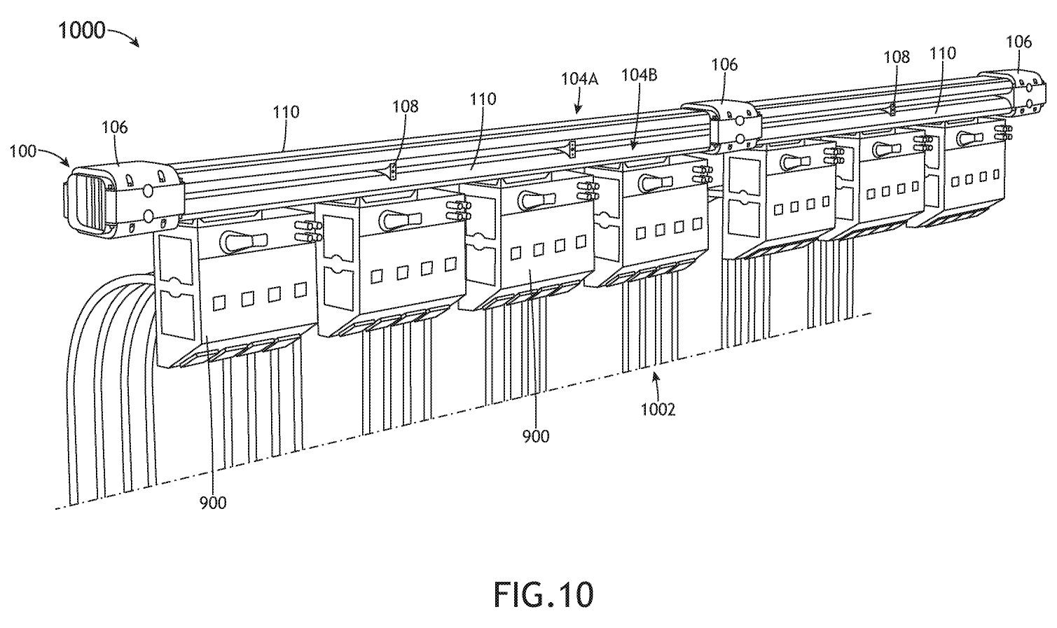

FIG. 10 illustrates a non-limiting example of an electrical distribution system 1000 including a multiple busway stack 100 including a plurality of segments 110 that are electrically coupled through a plurality of stack joint packs 106 to form the first and second busways 104A, 104B. The electrical distribution system 1000 further includes a plurality of tap off units 900 mounted to the second busway 104B corresponding to the bottom busway, with each tap off unit 900 configured to engage and make electrical contact with the buses 112 housed within the segments 110. Cabling 1002 from each tap off unit 900 may be routed to an electrical load.

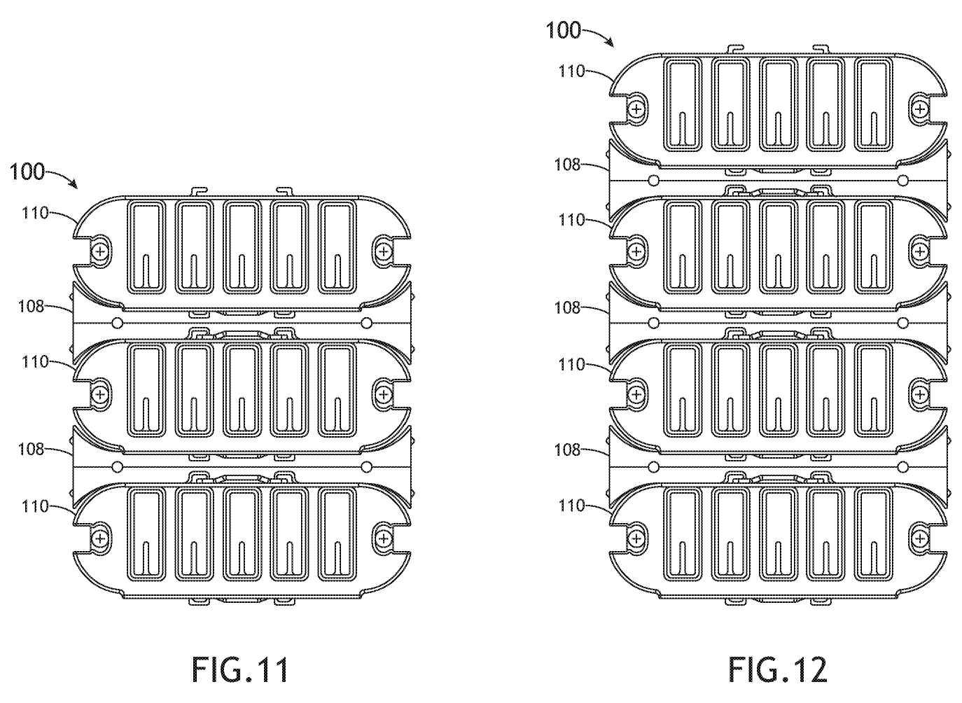

FIGS. 11 and 12 are end views of respective triple and quad versions of stacked busways of the busway system 100. In the triple stack configuration illustrated in FIG. 11, three separate busway segments 110 are connected using two separate mechanical joint blocks 108 to form a vertical stack of busways. In the quad stack configuration illustrated in FIG. 12, four separate busway segments 110 are connected using three separate mechanical joint blocks 108 to form a vertical stack of busways. Although not shown, each triple stack may be electrically coupled to at least one other like triple stack using at least one stack joint pack 106 having a triple stack joint pack configuration. Likewise, each quad stack may be electrically coupled to at least one other like quad stack using at least one stack joint pack 106 having a quad stack joint pack configuration. The stack joint packs 106 may be built in height by increasing the ‘height’ of the sidewalls 160 or by connecting a number of separate sidewalls 160 together.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively "associated" such that the desired functionality is achieved. Hence, any two components herein combined to achieve a particular functionality may be seen as "of" each other such that the desired functionality is achieved, irrespective of architectures or intermedial components. Likewise, any two components so associated may also be viewed as being "operably connected", or "operably coupled", to each other to achieve the desired functionality, and any two components capable of being so associated may also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Additionally, it is to be understood that the various embodiments presented herein may be considered collectively and not necessarily as completely distinct from one another, unless otherwise expressly stated. That is, it is to be understood that elements from the various embodiments may, indeed, be “mixed and matched” with one another where not specifically precluded.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A stack joint pack for electrically coupling stacks of busways, comprising:
a pack housing having opposing ends, each end configured to receive at least ends of stacked busway segments;
a plurality of insulative dividers disposed in the pack housing;
a plurality of conductive channels formed between adjacent ones of the plurality of insulative dividers, each conductive channel configured to receive a plurality of respective sets of buses of the stacked busway segments; and
a plurality of bridge buses disposed in the plurality of conductive channels, each bridge bus configured to electrically interconnect a respective set of the buses of the stacked busway segments configured to be received in the opposing ends of the pack housing.

2. The stack joint pack of claim 1, wherein the pack housing comprises:
a first housing;
a second housing; and
opposing sidewalls disposed between and removably attachable to the first and second housings.

3. The stack joint pack of claim 1, wherein the opposing sidewalls are configured to secure to at least one mechanical joint block of the stacks of busways.

4. The stack joint pack of claim 2, wherein the plurality of insulative dividers are parallel and are mounted to or integrally formed with one of the first housing and the second housing.

5. The stack joint pack of claim 2, wherein the plurality of insulative dividers extend from the first housing toward the second housing and are parallel to the opposing sidewalls.

6. The stack joint pack of claim 1, wherein the plurality of bridge buses are mounted in the pack housing by at least one transverse mounting post.

7. A stack joint pack for electrically coupling busway segments, comprising:
a pack housing having opposing ends configured to receive ends of aligned busway segments;
a plurality of conductive channels formed in the pack housing and configured to receive buses of the aligned busway segments; and
a plurality of bridge buses disposed in the conductive channels and configured to electrically interface with the buses of the aligned busway segments to facilitate electrical connections.

8. The stack joint pack of claim 7, wherein the opposing ends of the pack housing are configured to receive stacked busway segments.

9. The stack joint pack of claim 8, wherein the opposing ends of the pack housing are configured to receive and secure therein mechanical joint blocks mounted to the stacked busway segments.

10. The stack joint pack of claim 7, wherein the pack housing comprises:
a first housing;
a second housing; and
opposing sidewalls disposed between and removably attachable to the first and second housings.

11. The stack joint pack of claim 7, wherein the pack housing has a closed top, a closed bottom, and closed sides.

12. The stack joint pack of claim 7, wherein the plurality of conductive channels are delimited by a plurality of insulative dividers disposed in the pack housing.

13. The stack joint pack of claim 12, wherein the plurality of insulative dividers are mounted to or integrally formed with the pack housing.

14. A busway system, comprising:
a plurality of stacks of busway segments including at least a first stack of busway segments and a second stack of busway segments; and
a stack joint pack for electrically coupling the first stack of busway segments and the second stack of busway segments, the stack joint pack comprising:
a pack housing having first and second opposing ends, wherein the first end is configured to receive ends of the first stack of busway segments and the second end is configured to receive ends of the second stack of busway segments;
a plurality of insulative dividers disposed in the pack housing;
a plurality of conductive channels formed between adjacent ones of the plurality of insulative dividers, each conductive channel configured to receive a plurality of respective sets of buses of the first and second stacks of busway segments; and
a plurality of bridge buses disposed in each of the plurality of conductive channels, each bridge bus configured to electrically interconnect a pair of the buses of the first and second stacks of busway segments.

15. The busway system of claim 14, wherein the first stack of busway segments and the second stack of busways segments, when electrically coupled through the stack joint pack, are longitudinally aligned and form a plurality of electrically continuous busways.

16. The busway system of claim 14, wherein the pack housing comprises:
a first housing;
a second housing; and
opposing sidewalls disposed between and removably attachable to the first and second housings.

17. The busway system of claim 16, wherein the opposing sidewalls are configured to secure to at least one mechanical joint block of the first stack of busway segments, and at least one mechanical joint block of the second stack of busway segments.

18. The busway system of claim 16, wherein the plurality of insulative dividers are parallel and are mounted to or integrally formed with one of the first housing and the second housing.

19. The busway system of claim 16, wherein the plurality of insulative dividers extend from the first housing toward the second housing and are parallel to the opposing sidewalls.

20. The busway system of claim 14, wherein the plurality of bridge buses are mounted in the pack housing by at least one transverse mounting post.
